(19) United States
(12) Patent Application Publication
(10) Pub. No.: US 2009/0084564 A1
(43) Pub. Date: Apr. 2, 2009

(54) Ergonomic Trenching Chunker

(75) Inventors: James M. Buck, Keller, TX (US); Phillip M. Spradlin, Keller, TX (US)

Correspondence Address: VERIZON;PATENT MANAGEMENT GROUP, 1320 North Court House Road, 9th Floor, ARLINGTON, VA, 22201-2909, US

(73) Assignee: GTE Southwest Incorporated, d/b/a Verizon Southwest, Irving, TX (US)

(21) Appl. No.: 11/863,325

(22) Filed: Sep. 28, 2007

(51) Int. Cl. A01B 1/02

(52) U.S. Cl. 172/372; 172/371

(57) ABSTRACT

Apparatus for digging a trench in the soil for the purpose of installing underground infrastructure such as underground communication cable, underground sprinkler hoses, invisible underground dog fences, etc. The apparatus, termed a “chunker” is designed ergonomically to reduce muscle fatigue normally experienced by a trench-digger and to improve safety. The handle is ergonomically designed to accommodate the natural orientation of the hands. The length of the chunker can be adjustable to accommodate different heights of different people using the chunker. The chunker can be weighted for low center of gravity to improve stability and accuracy in usage. The spade-blade at the bottom of the chunker is oriented in a direction parallel to the intended route of the trench, allowing the trench-digger to widely straddle the line of the trench to avoid foot injury as the blade is vigorously thrown vertically downward into the soil near the trench-digger's body. The forming of the trench involves an easier left-right movement of the ground-inserted chunker instead of a forward-backward movement.

### BACKGROUND

Installation of underground cable, piping and wiring infrastructure for homeowner use is a familiar activity. For example, installation of underground communication cable such as fiber optic cable for connection to the homeowner's house, installation of underground water conduits for lawn sprinkler systems around the house, installation of underground invisible canine fences in the front yard of the house, etc. are familiar installations in some suburban areas today. These installations typically require hand-digging of a suitable trench or trenching system to accommodate the buried cable or other buried infrastructure.

When a communication cable is being installed in an underground-utilities-only subdivision of homes, the cable typically runs from a telecommunication company's “handhole” located near the street, underground, to an optical network terminal (ONT) affixed to the homeowner's house or condo, etc. The depth of the trench in which the cable is buried is typically seven inches, or so.

Current installation tools include ordinary shovels and spades. Spade work is relatively slow. Downward-thrusting cable trenching tools, or “chunker tools,” are used to improve trenching speed. In one particular instance, the assignee of the present invention is currently using a chunker tool of fixed length, with a horizontally-oriented, cylindrical, two-handed, hand grip at one end of the chunker tool. There is a fixed length, cylindrical, vertical member connected from a mid-point in the hand grip to a spade-type blade at the other end of the transmitting member. The plane of the blade is substantially parallel to, or co-planar with, the plane formed by the axes of rotation of the cylindrical hand grip and the cylindrical, vertical member.

This chunker tool is shown in FIG. 1. Hand grip 101 is permanently affixed to vertical member 102, of fixed length. Blade 104 is permanently affixed to vertical member 102 by way of collar 103 into which vertical member 102 is inserted. Essentially, this is similar to a fixed-length spade tool of common design, but with a two-handed grip to allow it to be forcefully thrust into the ground and raised with both hands.

The installer grasps the hand grip of the chunker apparatus with both hands and raises it vertically by about two-three feet off the ground. Then the installer uses arm, back, shoulder and hand forces to vigorously drive the blade vertically downward into the soil by moving the apparatus vertically downward in a rapid manner. When operating a conventional chunker, the blade penetrates the ground across, or transverse to, the direction of the feet of the installer, and the installer has to be oriented perpendicular to the direction of the trench being dug.

Current trenching tools, such as that depicted in FIG. 1, tend to cause shoulder, arm, wrist and back injuries. Indeed, when the tool is used with the necessary frequency required to install, for example, fiber optic cable in an underground cable subdivision of homes, these injuries may result. This appears to be caused, at least in part, by an uncomfortable position that must be assumed by the installer for safety purposes. The installer must make certain to stand back by a safe distance from the down-rushing blade to avoid having his feet guillotined. The ordinary muscle stress resulting from repetitive downward vigorous motion of the installer's arms alternating with repetitive reverse upward pulling of the blade back out of the soil is exacerbated because of the need for standing back from a trenching target line on the ground by this safety-precaution distance.

Other reasons for these injuries may be due to the uncomfortably-straight (not user friendly) handle and possibly uncomfortable length of the chunker relative to the height of a particular human installer or trench-digger. Another factor involved in these injuries is the heavy weight of the chunker.

Yet another reason for these injuries is the need for the installer to rock the inserted blade forward and backward in the ground relative to his position facing perpendicular to the line of the trench, in order to form the trench. This forward/backward rocking motion puts a strain on the installer's back.

### BRIEF DESCRIPTION OF THE DRAWINGS

FIG. 1 depicts a currently-available trenching chunker;

FIG. 2 depicts a front view of an embodiment of a trenching chunker in accordance with the principles of the present invention;

FIG. 3 depicts a side view of the trenching chunker of FIG. 2; and

FIG. 3A depicts an alternative implementation of the vertical arm, or force-transmitting member, of the trenching chunker of FIG. 3.

### DETAILED DESCRIPTION OF PREFERRED EMBODIMENTS

The trenching chunker or ground-trenching tool of the present invention is a two-handed gripping apparatus which has an ergonomically-advantageous hand grip with a bend at the midpoint of the hand grip. It has a blade that is oriented in a direction essentially parallel to, or aligned with, the direction of the installer's feet, rather than being transverse or perpendicular to the direction of those feet, when the operator is gripping the handle. A fixed length or adjustable-length, straight, connecting column rigidly connects the blade to the handle. (The terms installer, user, operator and trench-digger are used synonymously herein to signify a user of the chunker tool.)

In operation, the installer grasps the handle with both hands and lifts the tool into the air with the tool held vertically while the installer's arms are extended overhead. Then the installer, by force of his/her arms, drives the tool directly down to a target line on the soil/ground which outlines the direction of the intended trench. Because of the orientation of the blade, the installer can widely straddle the target line whereby the blade can be thrust into the ground close to the body of the installer and directly between the safely spread-apart feet of the installer, and move the embedded tool left and right to form the trench.

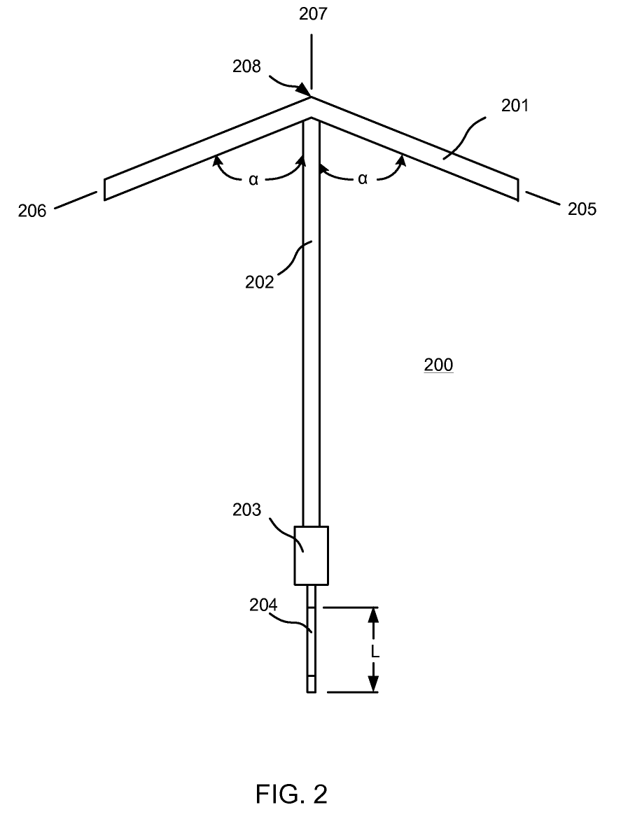

FIG. 2 depicts a front view of an embodiment of a trenching chunker 200 in accordance with the principles of the present invention. Ergonomically-designed handle 201 can be cylindrically-shaped with circular cross-section, or can be otherwise-shaped having virtually any other cross-section, such as, for example, elliptical, rectangular, hexagonal, octagonal, etc. Handle 201 is fixedly connected to force-transmitting member 202. For example, if both handle 201 and member 202 are stainless steel, then the two parts can be welded together. Member 202 can also be cylindrically shaped with circular cross section, or can have any other cross-sectional shape as noted above.

In FIG. 2, blade 204 is shown on edge. Thus, when the handles are gripped, the blade is aligned in the same direction as the feet of the installer, rather than transverse to the feet as in the currently-used chunker. The blade is attached to the bottom end of member 202 by way of collar 203 which is tight-fitted around member 202 and permanently bonded thereto. The bond could be accomplished by welding, epoxy-bonding, or other permanent means depending on the compositions of collar 203 and force-transmitting member 202. Blade and collar 203 are one piece and can be constructed from stainless steel, preferably. Member 202 can be stainless steel or a more-lightweight material, as long as it is sufficiently strong to stand up to the continuous pounding resulting from operation of the tool. It is preferable if most of the weight of the tool is at the bottom of the tool, in the blade, which will give the tool more stability when operating/throwing it into the ground.

Lines 205 and 206 represent longitudinal axes of handle 201, one axis for each of the two straight sections of handle, and, if cylindrical, represent axes of rotation for each of the two straight sections of handle 201. Line 207 represents a longitudinal axis of member 202 and, if cylindrical, represents an axis of rotation of member 202.

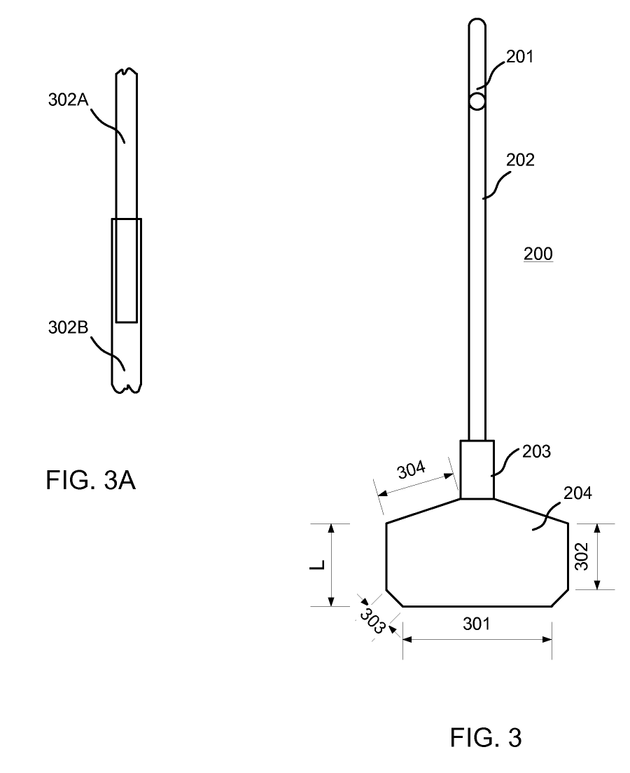

FIG. 3 depicts a side view of the trenching chunker 200 of FIG. 2. In this view, handle 201 is shown from its end, but blade 204 is shown in more detail than shown in FIG. 2. Blade 204 has two side ends 302 (only one side designated in FIG. 3), a lower end including edge 301 and tapered sections 303 (only one section designated in FIG. 3), and an upper end including tapered sections 304 (only one section designated in FIG. 3). Dimension “L” represents the distance from edge 301 to the start of tapered section 304. Dimension L can be about seven (7) inches. This is a visual depth gauge which permits the chunker-operator to know if the depth of the trench is appropriate. In other words, when the chunker is embedded into the soil to a depth corresponding to this location on the blade, the blade is properly inserted to create a trench of seven inches deep.

Returning to FIG. 2, handle 201 can be formed from a cylindrically-shaped solid rod or hollow tube, from steel or, preferably, a more light-weight metal. Its outside diameter is suitable for grasping by both hands of a human trench-digger, for example, a one-inch diameter. The handle is formed by bending it at its midpoint 208, as depicted, resulting in angle α, the angle between each end of the handle and force transmitting member 202 (i.e., vertical rod or tube 202). Typically, angle α is approximately 65° (sixty-five degrees). Alternatively, handle 201 can be formed from two separate pieces, each securely fastened to member 202, e.g., two wooden handle pieces with tongue and groove and reinforced angle-iron connections to a wooden force-transmitting member 202.

This angle is chosen because it is ergonomically advantageous. When a human is standing in a resting position with arms extended vertically downward in a relaxed manner, the hands are oriented at an angle that conforms to angle α. In other words, if that person raised his/her hands to a horizontal position by bending the arms at the elbows, while keeping the upper arms vertically oriented at the sides of the body, the hands would be oriented at angle α. Therefore, this angle is chosen as a comfortable angle for the hand grip—an ergonometric improvement over the right-angled orientation of the currently-used chunker handle. This angled grip reduces arm strain by allowing the user to engage more arm muscles when lifting the tool.

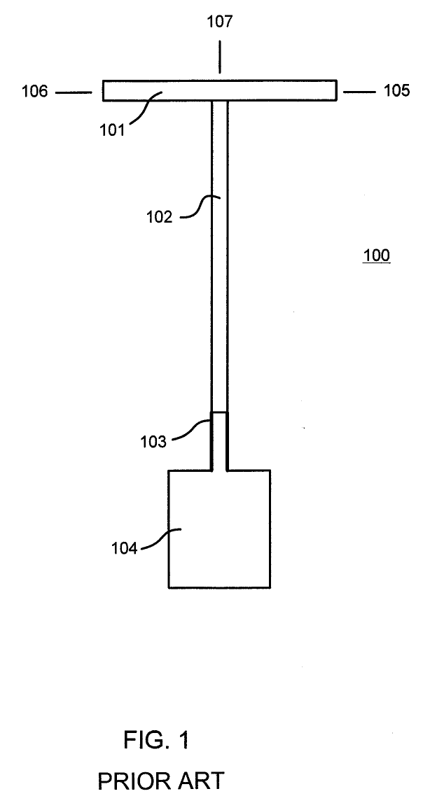

In addition, the length of the handle has been extended for good reason. The length of the handle, measured from midpoint 208 to either end, is at least one foot and could be eighteen inches or more. Applicants know from experience with the currently used chunker of FIG. 1 that arm muscles of the installer (trench-digger) are the muscles that get tired first from continuous thrusting of the blade into, and removal of the blade out from, the ground. The hand grip that is used is an over-grip (i.e., knuckles on the top of the handle) in which the hands are initially narrowly spaced at the start of the workday. That is, the hands grasp handle 201 relatively close to vertical rod 202. But, as the arm muscles get tired, the installer spreads his/her hands outwardly along the handle which brings the shoulder and back muscles into play more than they had been, to assist the arms in the vigorous chunking movement. Therefore, a handle with greater length offers some flexibility for the installer to at least momentarily use a wider grip to ease the arm strain.

Handle 201 can be knurled so that a good grip can be achieved. Alternatively, handle 201 can be rubberized, or otherwise padded with a non-skid material, to improve the gripping action. The ends can be capped with rubber end pieces for safety purposes, and thereby avoid causing cuts from sharp-edged metal.

FIG. 3A depicts an alternative implementation of force-transmitting member 202, of trenching clinker 200 of FIG. 3. Force-transmitting sub-member 302A (hereinafter, “slideable arm 302A”) telescopes inside force-transmitting sub-member 302B (hereinafter, “sleeve 302B”). This embodiment offers an easily adjustable chunker tool length to accommodate varying heights of different human trench-diggers. The ergonomically ideal height of the tool is for the top of the tool to correspond to just above the trench-digger's belt buckle when the blade is inserted seven inches into the soil. This dimension may permit the greatest force in the downward thrust.

Slideable arm 302A is inserted into sleeve 302B to the extent necessary to provide the appropriate length of tool 200. When the appropriate length is reached, a metal pin, such as a steel bolt (not shown), can be inserted into, and through, aligned-holes in both slideable arm 302A and sleeve 302B, and tightened into place with a mating nut. Several bolt-nut combinations can be used through multiple aligned-holes for added solidity. Alternatively, several different fixed-length chunkers can be made to accommodate taller and shorter people.

In operation, using the chunker of FIGS. 2/3, a trench-digger can straddle the line of the intended trench and, with feet spread safely apart (e.g., shoulder width or more) the chunker can be thrust downward with the tool at a close distance from the operator's body, thereby reducing fatigue as compared with distance needed using the currently-available chunker. Also, taper 303 offers safety advantages: even if a steel-tipped boot worn by the trench digger is hit by the blade of the preferred embodiment, it is hit a glancing blow and the ground is hit first by edge 301 before the steel tipped boot is hit by tapered-edge 303. This is a safety advantage. The steel protection in the boot extends only about three inches back measured from the tips of the toes, wherefore a transverse slice accident on the foot at a place beyond the steel-tip protection could result in serious foot injury including loss of the foot.

Furthermore, in order to form a trench after the blade has been inserted into the soil, the chunker in accordance with the present invention permits a left-right movement of the upper end of the chunker to cause the soil-inserted blade to move the soil in a manner to form the trench. This left-right movement performed by the user is easier on back muscles than a forward-backward movement which was needed when using the conventional chunker. This back strain was especially noticed when there was a relatively large distance between the inserted chunker and the feet of the user.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow.

For example, additional weight may be permanently added to the blade area near the bottom of the chunker by making the sleeve extra thick and/or by having the upper end of the blade near the sleeve made thicker with more steel. (The edge 301 needs to be kept relatively thin/sharp for easy soil penetration). The reason for this extra weight is to provide stability to the tool. The center of gravity of the chunker shall be positioned lower if the weight is skewed in the direction of the blade. The ideal weight for the chunker for most people is under twenty pounds, If lightweight material is used for handle 201 and for force-transmitting member 202, such as, for example, wood, aluminum or durable plastic, extra steel can be added to the blade/sleeve component while keeping the total weight below twenty pounds. On the other hand, if a particularly strong operator wants a heavier than average tool, it can be made completely from stainless steel with extra steel thickness at bottom, as described above.

Accordingly, the specification and drawings are to be regarded in an illustrative rather than restrictive sense.

1. A ground-trenching chunker comprising:
an ergonomically-designed handle configured for grasping by both hands of a trench-digger to lift said chunker above said ground, said handle consisting of a cylindrically-shaped handle-member bent at its midpoint at an angle which is ergonomically-advantageous to said trench-digger when grasping said handle and digging a trench;
a cylindrically-shaped, force-transmitting member having two ends, one of said ends being connected to said handle at said midpoint, the axis of rotation of said cylindrically-shaped, force-transmitting member and both axes of rotation associated with said handle being co-planar; and
a planar penetration-blade affixed to the other end of said force-transmitting member, said blade configured to be thrust from above said ground into said ground by said trench-digger. said blade oriented orthogonally to said co-planar plane.

2. The trenching chunker of claim 1 wherein:
said angle constrains said handle-member to conform to natural orientation of said both hands when gripping said handle-member in an overgrip.

3. The trenching chunker of claim 2 wherein:
said angle conforms to an angular displacement of approximately 65 degrees measured from each one of said axes of rotation and said axis of rotation.

4. The trenching chunker of claim 1 wherein:
the length of said handle measured from said midpoint to the each end of said member in directions parallel to said axes is at least twelve inches.

5. The trenching chunker of claim 1 wherein:
said planar penetration-blade has an upper end rigidly connected to said force-transmitting member, side ends defining outer limits of a width of said blade and a lower end having an edge for making contact with soil in which said trench is formed.

6. The trenching chunker of claim 5 wherein:
length of said edge is approximately half of said outer limits of said width of said blade, whereby said blade tapers in dimension from each of said outer limits of said width of said blade to its respective end of said edge.

7. The trenching chunker of claim 6 wherein:
said blade includes a depth gauge to indicate that said chunker has penetrated said soil to an appropriate trench depth, said gauge comprising a location on said blade where said outer width of said blade meets the start of said taper of said blade.

8. The trenching chunker of claim 6 wherein:
said cylindrically-shaped, force transmitting member is an adjustable telescoping rod and sleeve whereby effective length of said chunker is manually adjusted by said trench-digger to an ergonomically-suitable height.

9. The trenching chunker of claim 1:
wherein said chunker, frilly assembled, weighs less than twenty pounds; and
wherein center of gravity of said chunker is positioned in the direction of said blade by weighting said blade disproportionately.

10. A ground-trenching tool for underground installation comprising:
a handle configured in a manner to he grasped by both hands of an installer to lift said tool above said ground, handle including two members which interconnect at an angle which constrains said members to an ergonomically-suitable orientation for said installer, each of said two members having a straight handle longitudinal axis different from the longitudinal axis of the other member;
a straight leg having two ends, one of said ends being connected to said handle at said interconnection of said two members, said leg having a leg longitudinal axis; and
a spade-blade affixed to the other end of said leg, said spade-blade oriented in a direction that is parallel to a plane that is perpendicular to the plane formed by said handle longitudinal axis of said each of said two members in combination with said leg longitudinal axis, wherein said spade-blade is configured for thrusting into said ground from said above said ground by said installer applying downward force to said tool through said grasped handle.

11. The tool of claim 10 wherein said underground installation is an installation of communication cable.

12. The tool of claim 11 wherein said communication cable is fiber-optic cable.

13. The tool of claim 10 wherein said underground installation is an installation of a water conduit for a lawn-sprinkling system.

14. The tool of claim 10 wherein said underground installation is an installation of electrical wiring for an invisible animal restraint fence.

15. The tool of claim 10 wherein operation of said tool by said installer permits thrusting said blade into the ground by said installer between the feet of said installer while each foot of said installer remains located on opposite sides of the trench resulting from said thrusting.

16. The tool of claim 10 wherein said handle is cylindrically-shaped and said leg is cylindrically-shaped, and wherein said handle longitudinal axis is an axis of rotation and said leg longitudinal axis is an axis of rotation.

17. A ground-trenching tool comprising:
a handle bent at its midpoint into two straight sections providing two-handed gripping that is ergonomically advantageous to an operator lifting said tool above said ground;
a spade-blade of planar configuration oriented in a direction aligned with direction of feet of said operator when said operator is grasping said handle with both hands; and
a straight connecting column, rigidly connecting said spade blade to said handle at said midpoint;
whereby said operator picks up said tool to said above said ground and, Thereafter, thrusts said blade downward from said above said ground between feet of said operator into said ground and moves said tool left and right thereby moving said blade left and right in said ground to form said trench.
